(19) United States
(12) Patent Application Publication
(10) Pub. No.: US 2026/0177775 A1
(43) Pub. Date: Jun. 25, 2026

(54) OPTICAL IMAGING LENS

(71) Applicant: GENIUS ELECTRONIC OPTICAL (XIAMEN) CO., LTD., Xiamen (CN)

(72) Inventors: Zhizhong Ji, Xiamen (CN); Chen Chen, Xiamen (CN); Yidian Chen, Xiamen (CN)

(73) Assignee: GENIUS ELECTRONIC OPTICAL (XIAMEN) CO., LTD., Xiamen (CN)

(21) Appl. No.: 19/060,787

(22) Filed: Feb. 24, 2025

(30) Foreign Application Priority Data
Dec. 24, 2024 (CN) 202411918315.4
Jan. 21, 2025 (CN) 202510091847.3

(51) Int. Cl. G02B 7/02

(52) U.S. Cl. CPC G02B 7/021; G02B 7/025

(57) ABSTRACT

An optical imaging lens includes an outer cover, a lens barrel, and multiple lens elements disposed in the lens barrel. A front end portion of the lens barrel includes a lens barrel object-side opening. A back end portion of the lens barrel includes a lens barrel image-side opening. An inner diameter of the lens barrel object-side opening is less than an inner diameter of the lens barrel image-side opening. The outer cover is cone-shaped and is disposed on an outer surface of the front end portion of the lens barrel. The outer cover includes an outer cover object-side opening and an outer cover image-side opening. A maximum outer diameter of the outer cover object-side opening is less than a maximum outer diameter of the outer cover image-side opening. A length of the outer cover on an optical axis is greater than 40% of a length of the lens barrel on the optical axis.

### CROSS-REFERENCE TO RELATED APPLICATION

This application claims the priority benefits of China application serial no. 202411918315.4, filed on Dec. 24, 2024 and China application serial no. 202510091847.3, filed on Jan. 21, 2025. The entirety of each of the above-mentioned patent applications is hereby incorporated by reference herein and made a part of this specification.

### BACKGROUND

### Technical Field

The disclosure relates to an optical element, and more particularly, to an optical imaging lens.

### Description of Related Art

Specifications of portable electronic devices are constantly evolving, and key components thereof, optical imaging lenses, are also required to be continuously improved in specifications to meet consumer demands and be applied in various fields. Those skilled in the art know that using plastic materials to manufacture lens barrels, in addition to being easy to process, may also reduce the weight and cost, and therefore are widely applied in various optical lenses.

In the Chinese Utility Model Patent, CN209387961U, a lens module is provided. A metal insert is disposed in a plastic lens barrel. A supporting portion of the metal insert is disposed around an outer periphery of a top of the plastic lens barrel, which may protect the plastic lens barrel and improve structural strength of a top position of the lens barrel, so that the top of the lens barrel has good pressure resistance. However, from the cross-section, it has a structure with chamfers, where stress is more concentrated. Although it has pressure resistance at the top, it is easily damaged at a front end of a lens by impacts from other directions. In addition, no solution is provided for both reducing stray light and resisting drops.

In the Chinese Utility Model Patent, CN209525509U, in order to solve an issue that when a threadless lens barrel structure is matched with the lens, since strong glue is required to be used for high temperature curing, a thinner portion of a lens barrel wall thickness will be deformed, making it difficult for the lens to be matched with the lens barrel, a solution is provided. An implementation method thereof is to affix a metal sleeve to an outer surface of the lens barrel, so that after the lens barrel is cured at a high temperature, the thinner portion of the lens barrel wall thickness is protected by the metal sleeve, thereby enhancing overall strength of the lens barrel, making it less likely to deform, improving an ability of the lens barrel to resist deformation, and thus improving performance of the lens module. The lens barrel and the metal sleeve are integrally formed during an injection molding process, which may increase firmness of the lens module. However, in this case, it also has a structure with chamfers, where stress is more concentrated. In addition, it does not provide a method for improving structural strength of a top of an object-side end of the lens barrel while reducing the stray light, and it does not disclose how to maintain the structural strength of the lens while reducing a volume of the lens to prevent external impacts and drops from affecting performance of the lens.

In the Chinese utility model patent, CN208907936U, a lens module is provided. A lens barrel thereof includes a metal sleeve embedded in the lens barrel, and the lens barrel and the metal sleeve are formed integrally. The metal sleeve embedded in the lens barrel may greatly improve the ability of the lens barrel to resist deformation, so that when the lens barrel is assembled to the lens module, it will not be deformed due to the use of the strong glue for high temperature curing, thereby improving assembly stability and improving a product yield. However, the manufacturing difficulty and cost of this metal sleeve embedded in the lens barrel are high, and it also has a structure with chamfers, where stress is more concentrated. In addition, since an impact-receiving surface is still made of a plastic material, impact resistance is limited under the volume of the miniaturized lens.

With a trend of the portable electronic devices pursuing thin and short sizes, a volume of the lens module is getting smaller and smaller. Therefore, strength of the plastic material is no longer sufficient for the lens barrel to resist collisions and drops, resulting in the lens barrel being unable to protect internal components. Therefore, it is an objective that is required to be worked on today to provide a simple and economical way to improve the structural strength of the miniaturized lens module and prevent the external impacts and drops from affecting the performance of the lens while reducing the stray light.

### SUMMARY

The disclosure provides an optical imaging lens, which may facilitate an arrangement of an outer cover, a lens barrel, and multiple lenses in sequence for easy assembly, enhance structural strength of a front end portion of the lens barrel, reduce a volume of the optical imaging lens, while improving drop resistance.

The disclosure provides an optical imaging lens, including an outer cover, a lens barrel, and multiple lens elements disposed in the lens barrel along an optical axis from an object side to an image side. The lens barrel includes a front end portion close to the object side and a back end portion close to the image side. The front end portion includes a lens barrel object-side opening. The back end portion includes a lens barrel image-side opening. An inner diameter of the lens barrel object-side opening is less than an inner diameter of the lens barrel image-side opening. The front end portion of the lens barrel has a lens barrel annular plane perpendicular to the optical axis and located on a reference plane. The outer cover is cone-shaped and is disposed on an outer surface of the front end portion of the lens barrel. The outer cover includes an outer cover object-side opening and an outer cover image-side opening, and a maximum outer diameter of the outer cover object-side opening is less than a maximum outer diameter of the outer cover image-side opening. The outer cover includes an outer cover annular plane close to the object side and perpendicular to the optical axis, and an inner ring conical surface and an outer cover conical surface adjacent to the outer cover annular plane. A length of the outer cover on the optical axis is greater than 40% of a length of the lens barrel on the optical axis. The optical imaging lens satisfies a following condition, 0.450≤Tcv/Wbr≤1.400, where Tcv is a thickness of the outer cover on the reference plane, and Wbr is a width of the lens barrel annular plane on the reference plane.

In an embodiment of the disclosure, the optical imaging lens further includes a pressure sensitive adhesive disposed between the outer cover and the lens barrel.

In an embodiment of the disclosure, the outer cover includes at least one outer cover embedding structure. The lens barrel includes at least one lens barrel embedding structure. The outer cover is combined with the at least one lens barrel embedding structure of the lens barrel through the at least one outer cover embedding structure.

In an embodiment of the disclosure, a number of the at least one outer cover embedding structure is the same as a number of the at least one lens barrel embedding structure, and the at least one lens barrel embedding structure is a protruding structure and is adjacent to the outer cover image-side opening.

In an embodiment of the disclosure, a number of the at least one outer cover embedding structure is the same as a number of the at least one lens barrel embedding structure, and the at least one lens barrel embedding structure is a groove structure and is located at the outer cover image-side opening.

In an embodiment of the disclosure, one of the lens elements closest to the object side is a first lens element, and the outer cover is in contact with an object-side surface of the first lens element.

In an embodiment of the disclosure, an included angle between the outer cover annular plane and the outer cover conical surface is between 100 and 110 degrees.

In an embodiment of the disclosure, a material of the outer cover is metal.

In an embodiment of the disclosure, the outer cover may be a soft material, and a Shore A hardness thereof ranges from 70 to 90.

In an embodiment of the disclosure, the outer cover is in contact with the lens barrel annular plane.

In an embodiment of the disclosure, the optical imaging lens satisfies a following condition, 1.120≤Dcv/Dbr≤1.201, where Dcv is a maximum outer diameter of the outer cover on the reference plane, and Dbr is a maximum outer diameter of the lens barrel on the reference plane.

In an embodiment of the disclosure, the optical imaging lens satisfies a following condition, 1.000≤Dinmax/Dinmin≤1.400, where Dinmax is a maximum inner diameter of the inner ring conical surface, and Dinmax is a minimum inner diameter of the inner ring conical surface.

In an embodiment of the disclosure, the optical imaging lens satisfies a following condition, 1.150≤Dcvox/Dcvon≤1.500, where Dcvox is a maximum outer diameter of the outer cover, and Dcvon is a minimum outer diameter of the outer cover.

Based on the above, in the optical imaging lens of the disclosure, the optical imaging lens includes the outer cover, the lens barrel, and the lens elements disposed in the lens barrel along the optical axis from the object side to the image side. The front end portion of the lens barrel includes the lens barrel object-side opening, and the back end portion of the lens barrel includes the lens barrel image-side opening. The inner diameter of the lens barrel object-side opening is less than the inner diameter of the lens barrel image-side opening. Therefore, it is not only advantageous to arrange the outer cover, the lens barrel, and the lens elements in sequence for easy assembly, but also advantageous to reduce the volume of the optical imaging lens while maintaining the wall thickness of the lens barrel. In addition, the outer cover includes the outer cover object-side opening and the outer cover image-side opening, and the maximum outer diameter of the outer cover object-side opening is less than the maximum outer diameter of the outer cover image-side opening. Therefore, the configuration of the outer cover may help to improve the strength of the front end portion of the lens barrel. In addition, the length of the outer cover on the optical axis is greater than 40% of the length of the lens barrel on the optical axis. Therefore, the protection area of the lens barrel may be increased, and the bonding force between the outer cover and the lens barrel may also be increased, thereby improving the drop resistance. In addition, the cone shape of the outer cover is not only easy to process, but also may disperse the impact force when it is disposed on the outer surface of the lens barrel. The design thereof without the chamfered structure may also reduce the stress concentration, which may effectively avoid the external impacts or drops, thereby reducing the possibility of local deformation and protecting the safety of the internal components. In addition, the optical imaging lens satisfies the following condition, 0.450≤Tcv/Wbr≤1.400, where Tcv is the thickness of the outer cover on the reference plane, and Wbr is the width of the lens barrel annular plane on the reference plane. Therefore, by controlling the ratio of the width of the lens barrel annular plane to the thickness of the outer cover, the volume of the miniaturized lens may be maintained while ensuring the intensity of the drop resistance of the optical imaging lens.

In order for the aforementioned features and advantages of the disclosure to be more comprehensible, embodiments accompanied with drawings are described in detail below.

### BRIEF DESCRIPTION OF THE DRAWINGS

FIG. 1 is a schematic cross-sectional view of an optical imaging lens according to the first embodiment of the disclosure.

FIG. 2 is a schematic cross-sectional view of an optical imaging lens according to the second embodiment of the disclosure.

FIG. 3 is a schematic cross-sectional view of an optical imaging lens according to the third embodiment of the disclosure.

FIG. 4 is a schematic cross-sectional view of an optical imaging lens according to the fourth embodiment of the disclosure.

FIG. 5 is a schematic cross-sectional view of an optical imaging lens according to the fifth embodiment of the disclosure.

FIG. 6 is a schematic front view of an optical imaging lens according to the fifth embodiment of the disclosure.

FIG. 7 is a schematic front view of an optical imaging lens according to the sixth embodiment of the disclosure.

FIG. 8 is a schematic front view of an optical imaging lens according to the seventh embodiment of the disclosure.

FIG. 9 shows values of various important parameters and relational expressions thereof of the optical imaging lenses according to the first to fourth embodiments of the disclosure.

### DETAILED DESCRIPTION OF DISCLOSED EMBODIMENTS

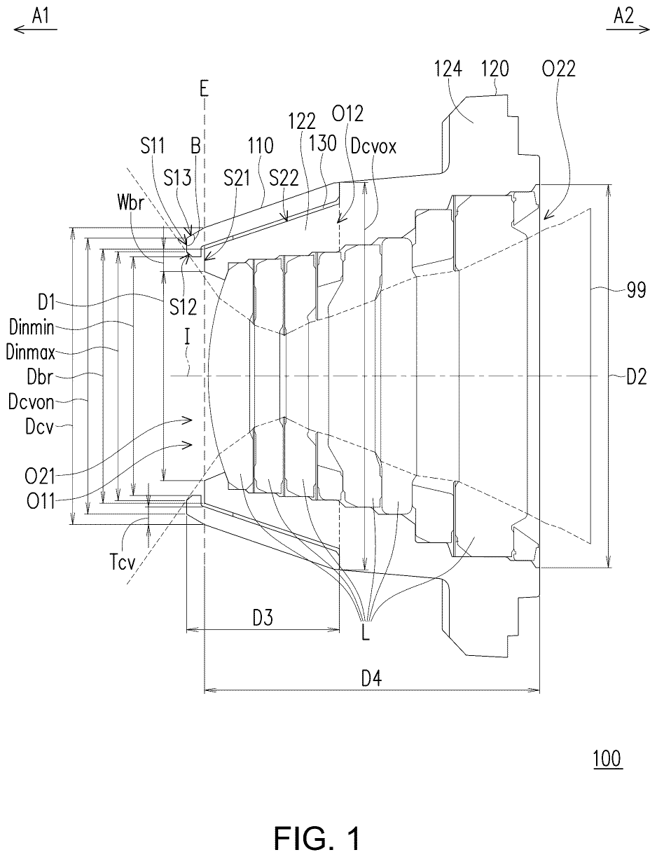

FIG. 1 is a schematic cross-sectional view of an optical imaging lens according to the first embodiment of the disclosure. Referring to FIG. 1, in this embodiment, an optical imaging lens 100 is provided, which includes an outer cover 110, a lens barrel 120, and multiple lens elements L disposed in the lens barrel 120 along an optical axis I from an object side A1 to an image side A2. When light emitted by an object to be photographed enters the optical imaging lens 100 and passes through the lens elements L and filters, an image is formed on an image plane 99. In all embodiments of the disclosure, the number, shape, material, and type of the lens elements L are not limited.

The lens barrel 120 includes a front end portion 122 close to the object side A1 and a back end portion 124 close to the image side A2. Specifically, the front end portion 122 and the back end portion 124 are defined to distinguish relative positions, and the lens barrel 120 may be designed to be integrally formed without obvious boundaries. The front end portion 122 includes a lens barrel object-side opening O21, and the back end portion 124 includes a lens barrel image-side opening O22. An inner diameter D1 of the lens barrel object-side opening O21 is less than an inner diameter D2 of the lens barrel image-side opening O22. Therefore, it is not only advantageous to arrange the outer cover 110, the lens barrel 120, and the lens elements L in sequence for easy assembly, but also advantageous to reduce a volume of the optical imaging lens 100 while maintaining a wall thickness of the lens barrel 120. The front end portion 122 of the lens barrel 120 has a lens barrel annular plane S21 perpendicular to the optical axis I and located on a reference plane E, and an outer surface S22 facing away from a side of the optical axis I.

The outer cover 110 is cone-shaped, specifically, truncated cone-shaped, and is disposed on the outer surface S22 of the front end portion 122 of the lens barrel 120. The outer cover 110 includes an outer cover object-side opening O11 and an outer cover image-side opening O12. A maximum outer diameter of the outer cover object-side opening O11 (i.e., a minimum outer diameter Dcvon of the outer cover 110) is less than a maximum outer diameter of the outer cover image-side opening O12 (i.e., a maximum outer diameter Dcvox of the outer cover 110). Therefore, the configuration of the outer cover 110 may help to improve strength of the front end portion 122 of the lens barrel 120. In addition, the cone shape of the outer cover 110 is not only easy to process, but also may disperse impact force when it is disposed on the outer surface S22 of the lens barrel 120. A design thereof without a chamfered structure may also reduce stress concentration, which may effectively avoid external impacts or drops, thereby reducing a possibility of local deformation and protecting safety of internal components. The outer cover 110 has an outer cover annular plane S11 close to the object side A1 and perpendicular to the optical axis I, an inner ring conical surface S12 adjacent to the outer cover annular plane S11 and facing the optical axis I, and an outer cover conical surface S13 adjacent to the outer cover annular plane S11 and away from the optical axis I. The inner ring conical surface S12 of the outer cover 110 not only reduces generation of stray light, but also enhances strength of the outer cover object-side opening O11. A length D3 of the outer cover 110 on the optical axis I is greater than 40% of a length D4 of the lens barrel 120 on the optical axis I, which may increase a protection area of the lens barrel and also increase bonding force between the outer cover 110 and the lens barrel 120, thereby improving drop resistance.

In this embodiment, the optical imaging lens 100 further includes a pressure sensitive adhesive (PSA) 130 disposed between the outer cover 110 and the lens barrel 120 to fix the outer cover 110 to the lens barrel 120. In this way, the bonding force may be increased, and the PSA 130 has buffering force, which may enable the optical imaging lens 100 to be more resistant to dropping.

In this embodiment, an included angle B between the outer cover annular plane S11 and the outer cover conical surface S13 is between 100 and 110 degrees. In this way, it may disperse the impact force and reduce the stress concentration. In this embodiment, the included angle B between the outer cover annular plane S11 and the outer cover conical surface S13 is, for example, 105 degrees.

In this embodiment, a material of the outer cover 110 is metal, which may provide the optical imaging lens 100 with high strength and hardness characteristics and good drop resistance.

In this embodiment, the outer cover 110 is in contact with the lens barrel annular plane S21 of the lens barrel 120. Therefore, the outer cover 110 may cover a front end of the lens barrel 120, thereby increasing impact resistance of the front end portion 122 of the lens barrel 120.

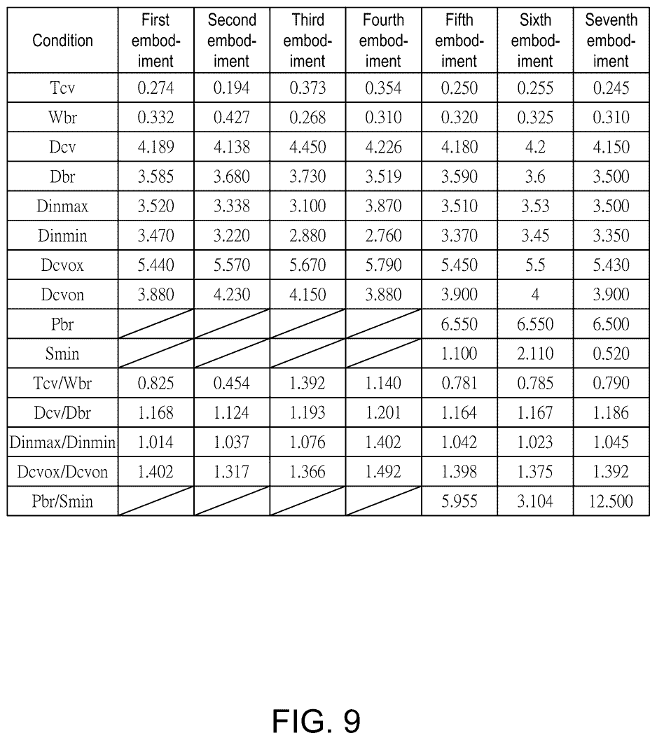

In addition, a relationship between various important parameters of the optical imaging lens 100 in the first embodiment is shown in FIG. 9,
where
Tcv is a thickness of the outer cover 110 on the reference plane E;
Wbr is a width of the lens barrel annular plane S21 on the reference plane E;
Dcv is a maximum outer diameter of the outer cover 110 on the reference plane E;
Dbr is a maximum outer diameter of the lens barrel 120 on the reference plane E;
Dinmax is a maximum inner diameter of the inner ring conical surface S12;
Dinmin is a minimum inner diameter of the inner ring conical surface S12;
Dcvox is the maximum outer diameter of the outer cover 110;
Dcvon is the minimum outer diameter of the outer cover 110.

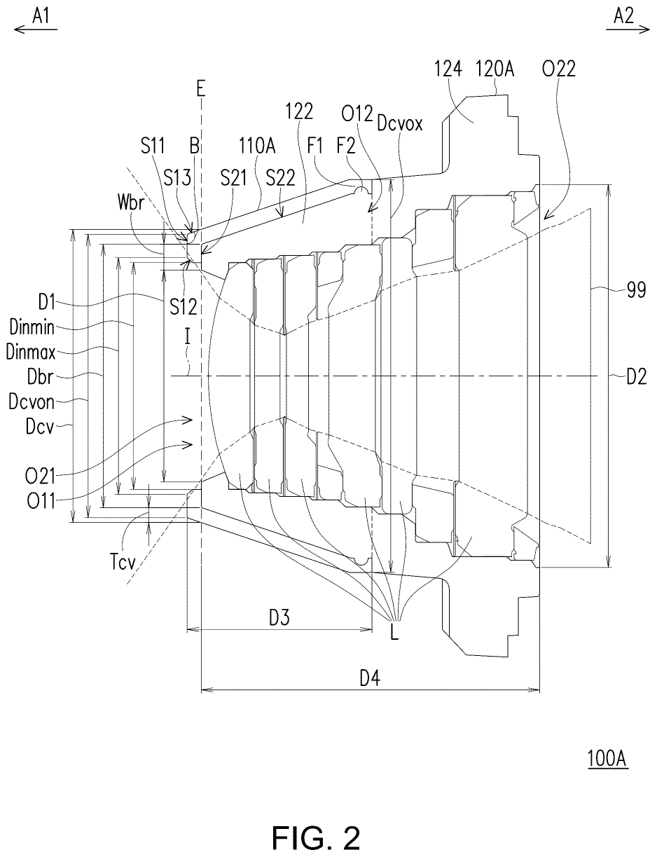

FIG. 2 is a schematic cross-sectional view of an optical imaging lens according to the second embodiment of the disclosure. Referring to FIG. 2, an optical imaging lens 100A in this embodiment is similar to the optical imaging lens 100 shown in FIG. 1. A difference between the two is that in this embodiment, an outer cover 110A and a lens barrel 120A are formed by insert injection. In this embodiment, the outer cover 110A includes at least one outer cover embedding structure F1, and the lens barrel 120A includes at least one lens barrel embedding structure F2. The outer cover 110A is combined with the at least one lens barrel embedding structure F2 of the lens barrel 120A through the at least one outer cover embedding structure F1. Therefore, compared to dispensing, in this embodiment, one step may be reduced, so the process is simple, and bonding strength of insert injection is stronger than that of glue. For example, in this embodiment, the numbers of the at least one outer cover embedding structure F1 and the at least one lens barrel embedding structure F2 are the same. The at least one lens barrel embedding structure F2 is a protruding structure, and is adjacent to the outer cover image-side opening O12. In this way, a bonding area may be further increased, and bonding force of the outer cover 110A may be strengthened. In this embodiment, the included angle B between the outer cover annular plane S11 and the outer cover conical surface S13 is 100 degrees. In addition, a relationship between various important parameters of the optical imaging lens 100A in the second embodiment is shown in FIG. 9.

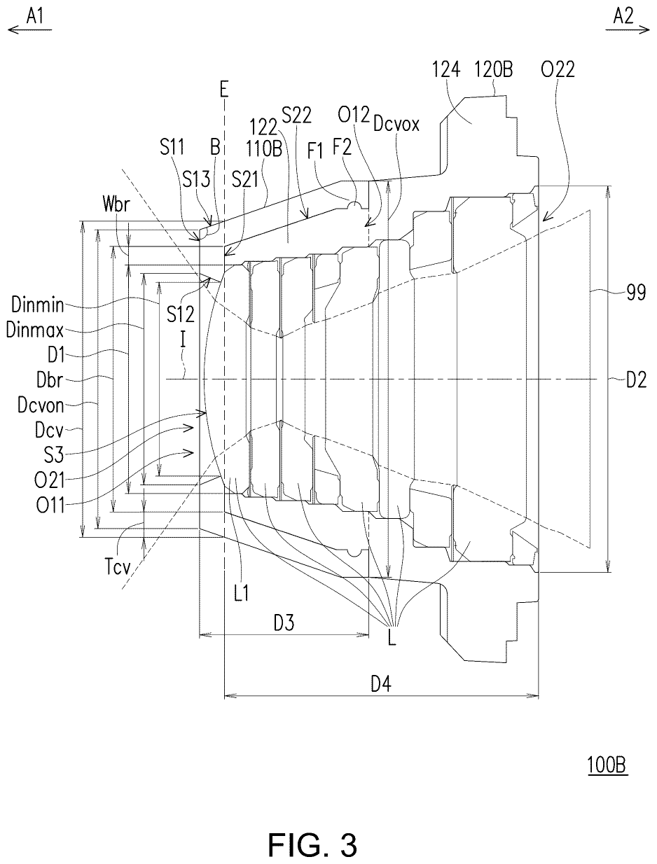

FIG. 3 is a schematic cross-sectional view of an optical imaging lens according to the third embodiment of the disclosure. Referring to FIG. 3, an optical imaging lens 100B in this embodiment is similar to the optical imaging lens 100 shown in FIG. 1. A difference between the two is that in this embodiment, an outer cover 110B and a lens barrel 120B are formed by insert injection. In this embodiment, the outer cover 110B includes the at least one outer cover embedding structure F1, and the lens barrel 120B includes the at least one lens barrel embedding structure F2. The outer cover 110B is combined with the at least one lens barrel embedding structure F2 of the lens barrel 120B through the at least one outer cover embedding structure F1. Therefore, compared to dispensing, in this embodiment, one step may be reduced, so the process is simple, and the bonding strength of insert injection is stronger than that of the glue. For example, in this embodiment, the numbers of the at least one outer cover embedding structure F1 and the at least one lens barrel embedding structure F2 are the same. The at least one lens barrel embedding structure F2 is the protruding structure, and is adjacent to the outer cover image-side opening O12. In this way, the bonding area may be further increased, and bonding force of the outer cover 110B may be strengthened. In addition, in this embodiment, one of the lens elements L closest to the object side A1 is a first lens element L1, and the outer cover 110B is in contact with an object-side surface S3 of the first lens element L1. In this way, a length of the lens barrel 120B may be shortened, thereby reducing a total length of the optical imaging lens 100B and preventing the lens barrel 120B from being in direct contact with other materials and being corroded. In this embodiment, the included angle B between the outer cover annular plane S11 and the outer cover conical surface S13 is 105 degrees. In addition, a relationship between various important parameters of the optical imaging lens 100B in the third embodiment is shown in FIG. 9.

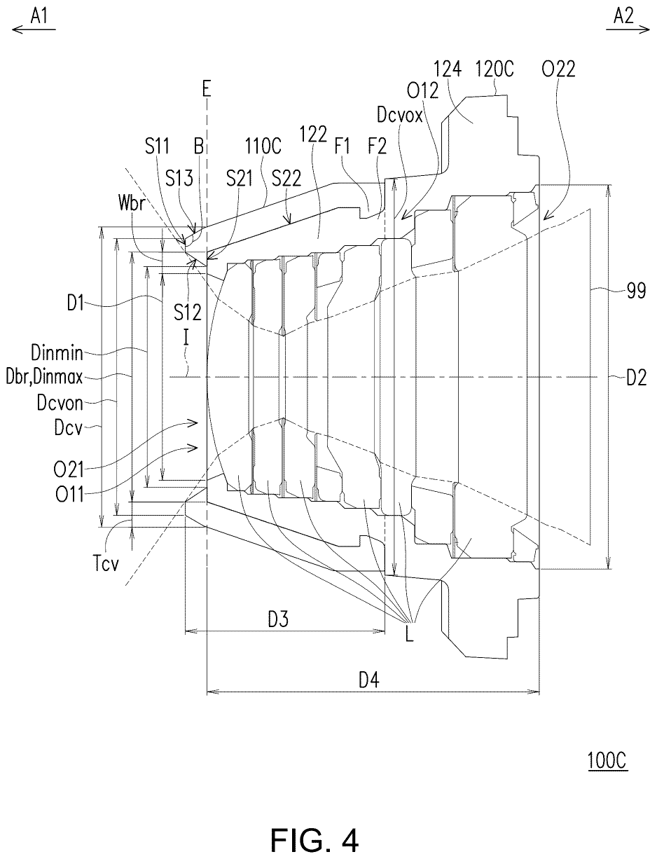

FIG. 4 is a schematic cross-sectional view of an optical imaging lens according to the fourth embodiment of the disclosure. Referring to FIG. 4, an optical imaging lens 100C in this embodiment is similar to the optical imaging lens 100 shown in FIG. 1. A difference between the two is that in this embodiment, an outer cover 110C and a lens barrel 120C are formed by insert injection. In this embodiment, the outer cover 110C includes the at least one outer cover embedding structure F1, and the lens barrel 120C includes the at least one lens barrel embedding structure F2. The outer cover 110C is combined with the at least one lens barrel embedding structure F2 of the lens barrel 120C through the at least one outer cover embedding structure F1. Therefore, compared to dispensing, in this embodiment, one step may be reduced, so the process is simple, and the bonding strength of insert injection is stronger than that of the glue. For example, in this embodiment, the numbers of the at least one outer cover embedding structure F1 and the at least one lens barrel embedding structure F2 are the same. The at least one lens barrel embedding structure F2 is a groove structure, and is adjacent to the outer cover image-side opening O12. In this way, the bonding area may be further increased, and bonding force of the outer cover 110C may be strengthened. In addition, in this embodiment, the outer cover 110C may be a soft material, and a Shore A hardness thereof ranges from 70 to 90. In this embodiment, the included angle B between the outer cover annular plane S11 and the outer cover conical surface S13 is 110 degrees. In addition, a relationship between various important parameters of the optical imaging lens 100C in the fourth embodiment is shown in FIG. 9.

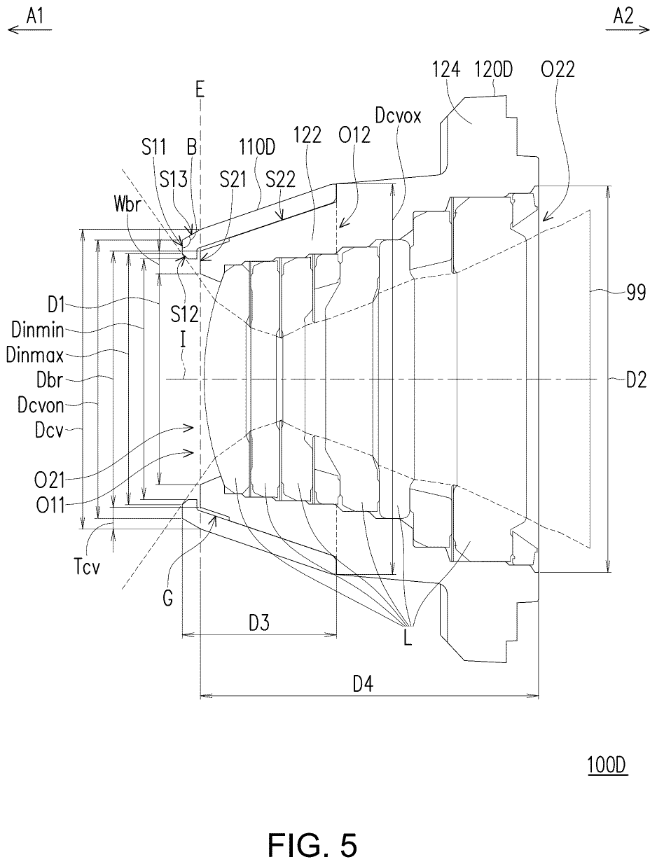

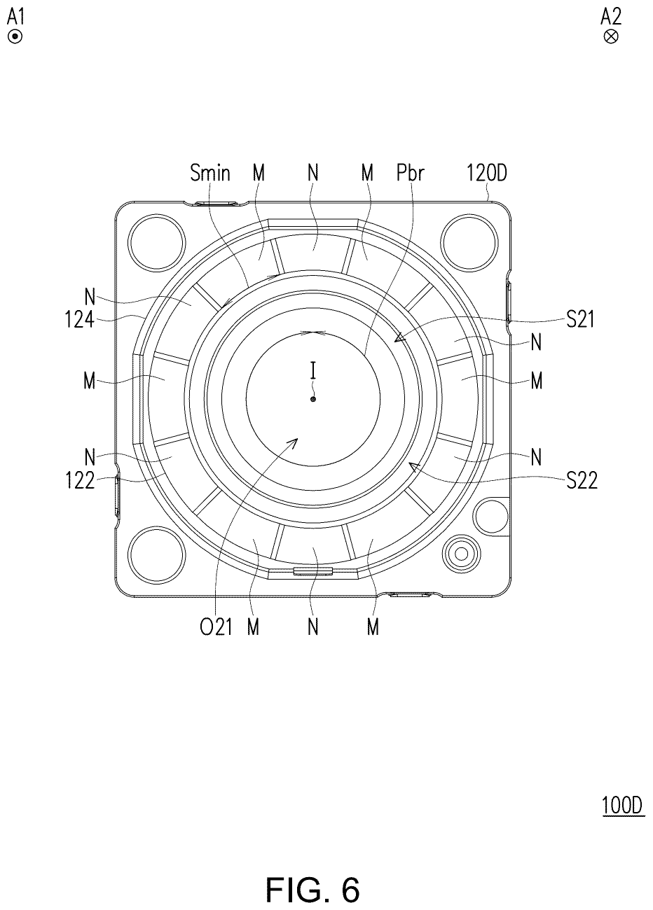

FIG. 5 is a schematic cross-sectional view of an optical imaging lens according to the fifth embodiment of the disclosure. FIG. 6 is a schematic front view of an optical imaging lens according to the fifth embodiment of the disclosure. Referring to FIG. 5 and FIG. 6, an optical imaging lens 100D in this embodiment is similar to the optical imaging lens 100 shown in FIG. 1. A difference between the two is that in this embodiment, an air gap G is disposed between the outer surface S22 of the front end portion 122 of a lens barrel 120D and an outer cover 110D. In this way, the air gap G may be used as a buffer structure to prevent the impact force from being directly transmitted to the front end portion 122 of the lens barrel 120D, thereby increasing the drop resistance. More specifically, a length of the air gap G on the optical axis I is 20% to 40% of a length of the outer cover 110D on the optical axis I. For example, in this embodiment, the length of the air gap G on the optical axis I is 30% of the length of the outer cover 110D on the optical axis I. In this way, by further designing a ratio of the length of the air gap G to the length of the outer cover 110D, an appropriate buffer capacity may be obtained, while also achieving an effect of improving an assembly yield.

On the other hand, in this embodiment, the outer surface S22 of the lens barrel 120D is provided with multiple dispensing areas M and multiple matching areas N arranged alternately. The number of dispensing areas M is the same as the number of matching areas N. More specifically, the number of dispensing areas M is at least 3 and at most 12. For example, in this embodiment, the outer surface S22 of the lens barrel 120D is provided with 6 dispensing areas M and 6 matching areas N arranged alternately. In this way, it is possible to avoid a combination of the outer cover 110D and the lens barrel 120D being unstable and failing to achieve a function of improving dimensional accuracy due to too few dispensing areas M, and to avoid the width being narrowed due to too many dispensing areas M, thereby reducing production efficiency. Each of the dispensing areas M has a receiving groove for receiving the glue, and a depth of the receiving groove is between 0.005 mm and 0.100 mm. The matching area N is in direct contact with the outer cover 110D. In addition, a relationship between various important parameters of the optical imaging lens 100D in the fifth embodiment is shown in FIG. 9.

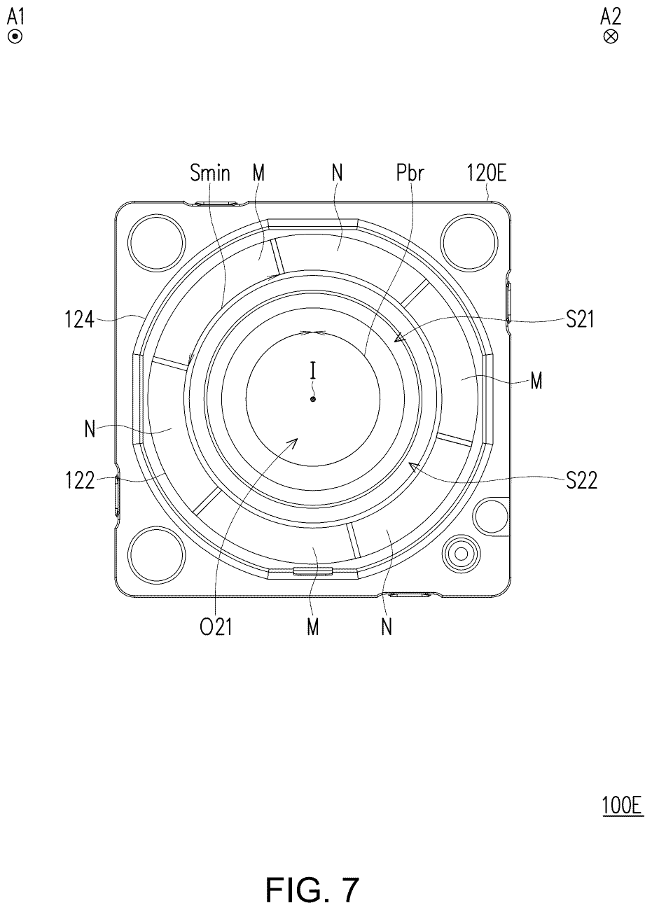

FIG. 7 is a schematic front view of an optical imaging lens according to the sixth embodiment of the disclosure. Referring to FIG. 7, for convenience of description, FIG. 7 shows the outer cover in a hidden manner. An optical imaging lens 100E in this embodiment is similar to the optical imaging lens 100D shown in FIG. 6. A difference between the two is that in this embodiment, the outer surface S22 of a lens barrel 120E is provided with 3 dispensing areas M and 3 matching areas N arranged alternately. In this way, it is possible to avoid a combination of the outer cover and the lens barrel 120E being unstable and failing to achieve the function of improving the dimensional accuracy due to too few dispensing areas M, and to avoid the width being narrowed due to too many dispensing areas M, thereby reducing the production efficiency. In addition, a relationship between various important parameters of the optical imaging lens 100E in the sixth embodiment is shown in FIG. 9.

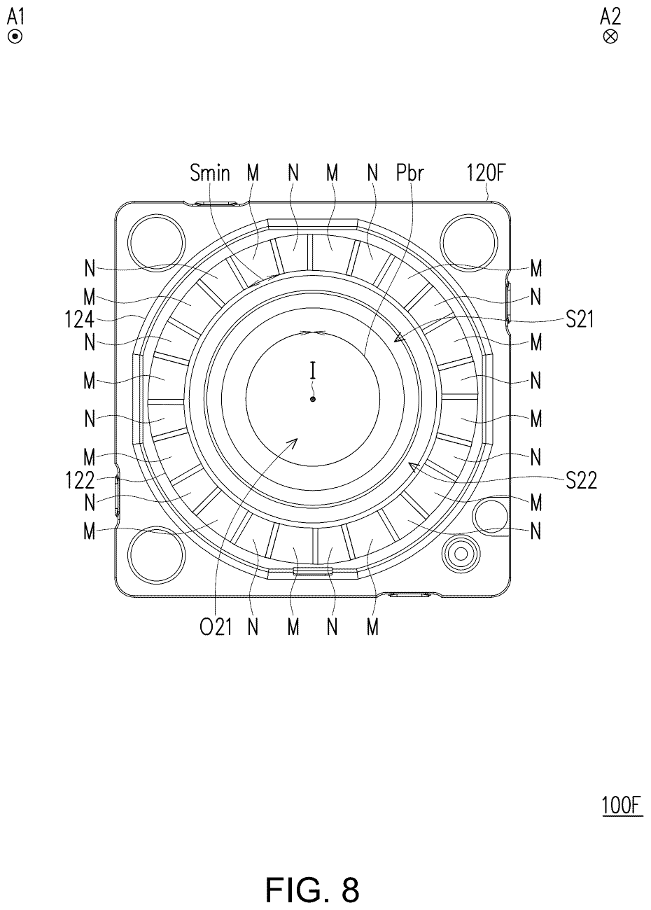

FIG. 8 is a schematic front view of an optical imaging lens according to the seventh embodiment of the disclosure. Referring to FIG. 8, for convenience of description, FIG. 8 shows the outer cover in a hidden manner. An optical imaging lens 100F in this embodiment is similar to the optical imaging lens 100D shown in FIG. 6. A difference between the two is that in this embodiment, the outer surface S22 of a lens barrel 120F is provided with 12 dispensing areas M and 12 matching areas N arranged alternately. In this way, it is possible to avoid a combination of the outer cover and the lens barrel 120F being unstable and failing to achieve the function of improving the dimensional accuracy due to too few dispensing areas M, and to avoid the width being narrowed due to too many dispensing areas M, thereby reducing the production efficiency. In addition, a relationship between various important parameters of the optical imaging lens 100F in the sixth embodiment is shown in FIG. 9.

In addition, in the above embodiments, when the optical imaging lenses 100 and 100A to 100F satisfy the following condition, 0.450≤Tcv/Wbr≤1.400, a ratio of the width Wbr of the lens barrel annular plane S21 to the thicknesses Tcv of the outer covers 110 and 110A to 110D may be controlled to maintain the volume of the miniaturized lens while ensuring intensity of the drop resistance of the optical imaging lenses 100 and 100A to 100F.

In addition, in the above embodiments, when the optical imaging lenses 100 and 100A to 100F satisfy the following condition, 1.120≤Dcv/Dbr≤1.201, a ratio of the maximum outer diameters Dbr of the lens barrels 120 and 120A to 120F to the maximum outer diameters Dcv of the outer covers 110 and 110A to 110D on the same plane may be controlled to maintain the volume of the miniaturized lens while ensuring the intensity of the drop resistance of the optical imaging lenses 100 and 100A to 100F.

In addition, in the above embodiments, when the optical imaging lenses 100 and 100A to 100F satisfy the following condition, 1.000≤Dinmax/Dinmin≤1.400, a slope of the conical surface S12 may be controlled by controlling a ratio of the maximum inner diameter Dinmax to the minimum inner diameter Dinmin of the inner ring conical surface S12 of the outer cover object-side opening O11, so as to achieve an effect of reducing the stray light.

In addition, in the above embodiments, when the optical imaging lenses 100 and 100A to 100F satisfy the following condition, 1.150≤Dcvox/Dcvon≤1.500, a slope of conical shapes of the outer covers 110 and 110A to 110D may be controlled by a ratio of the maximum outer diameter Dcvox to the minimum outer diameter Dcvon of the outer covers 110 and 110A to 110D, so as to achieve an effect of controlling and dispersing the impact force and reducing the stress concentration.

In addition, in the fifth to seventh embodiments, when the optical imaging lenses 100D, 100E, and 100F further satisfy the following condition, 3.100≤Pbr/Smin≤12.50, Pbr is a minimum circumference of the lens barrel object-side opening O21, and Smin is a minimum arc length of one of the dispensing areas M close to the object side A1. In this way, a dispensing area may be adjusted by controlling the arc length of the dispensing area M, and appropriate sizes of the lens barrels 120D, 120E, and 120F may be matched to improve the deformation of the lens barrels 120D, 120E, and 120F and improve a manufacturing yield.

Based on the above, in the optical imaging lens of the disclosure, the optical imaging lens includes the outer cover, the lens barrel, and the lens elements disposed in the lens barrel along the optical axis from the object side to the image side. The front end portion of the lens barrel includes the lens barrel object-side opening, and the back end portion of the lens barrel includes the lens barrel image-side opening. The inner diameter of the lens barrel object-side opening is less than the inner diameter of the lens barrel image-side opening. Therefore, it is not only advantageous to arrange the outer cover, the lens barrel, and the lens elements in sequence for easy assembly, but also advantageous to reduce the volume of the optical imaging lens while maintaining the wall thickness of the lens barrel. In addition, the outer cover includes the outer cover object-side opening and the outer cover image-side opening, and the maximum outer diameter of the outer cover object-side opening is less than the maximum outer diameter of the outer cover image-side opening. Therefore, the configuration of the outer cover may help to improve the strength of the front end portion of the lens barrel. In addition, the length of the outer cover on the optical axis is greater than 40% of the length of the lens barrel on the optical axis. Therefore, the protection area of the lens barrel may be increased, and the bonding force between the outer cover and the lens barrel may also be increased, thereby improving the drop resistance. In addition, the cone shape of the outer cover is not only easy to process, but also may disperse the impact force when it is disposed on the outer surface of the lens barrel. The design thereof without the chamfered structure may also reduce the stress concentration, which may effectively avoid the external impacts or drops, thereby reducing the possibility of local deformation and protecting the safety of the internal components. In addition, the optical imaging lens satisfies the following condition, 0.450≤Tcv/Wbr≤1.400, where Tcv is the thickness of the outer cover on the reference plane, and Wbr is the width of the lens barrel annular plane on the reference plane. Therefore, by controlling the ratio of the width of the lens barrel annular plane to the thickness of the outer cover, the volume of the miniaturized lens may be maintained while ensuring the intensity of the drop resistance of the optical imaging lens.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. An optical imaging lens, comprising an outer cover, a lens barrel, and a plurality of lens elements disposed in the lens barrel along an optical axis from an object side to an image side, wherein
the lens barrel comprises a front end portion close to the object side and a back end portion close to the image side;
the front end portion comprises a lens barrel object-side opening, the back end portion comprises a lens barrel image-side opening, and an inner diameter of the lens barrel object-side opening is less than an inner diameter of the lens barrel image-side opening;
the front end portion of the lens barrel has a lens barrel annular plane perpendicular to the optical axis and located on a reference plane;
the outer cover is cone-shaped and is disposed on an outer surface of the front end portion of the lens barrel;
the outer cover comprises an outer cover object-side opening and an outer cover image-side opening, and a maximum outer diameter of the outer cover object-side opening is less than a maximum outer diameter of the outer cover image-side opening;
the outer cover comprises an outer cover annular plane close to the object side and perpendicular to the optical axis, and an inner ring conical surface and an outer cover conical surface adjacent to the outer cover annular plane;
a length of the outer cover on the optical axis is greater than 40% of a length of the lens barrel on the optical axis; and
the optical imaging lens satisfies a following condition, 0.450≤Tcv/Wbr≤1.400, wherein Tcv is a thickness of the outer cover on the reference plane, and Wbr is a width of the lens barrel annular plane on the reference plane.

2. The optical imaging lens according to claim 1, further comprising a pressure sensitive adhesive disposed between the outer cover and the lens barrel.

3. The optical imaging lens according to claim 1, wherein the outer cover comprises at least one outer cover embedding structure, the lens barrel comprises at least one lens barrel embedding structure, and the outer cover is combined with the at least one lens barrel embedding structure of the lens barrel through the at least one outer cover embedding structure.

4. The optical imaging lens according to claim 3, wherein a number of the at least one outer cover embedding structure is the same as a number of the at least one lens barrel embedding structure, and the at least one lens barrel embedding structure is a protruding structure and is adjacent to the outer cover image-side opening.

5. The optical imaging lens according to claim 3, wherein a number of the at least one outer cover embedding structure is the same as a number of the at least one lens barrel embedding structure, and the at least one lens barrel embedding structure is a groove structure and is located at the outer cover image-side opening.

6. The optical imaging lens according to claim 1, wherein one of the lens elements closest to the object side is a first lens element, and the outer cover is in contact with an object-side surface of the first lens element.

7. The optical imaging lens according to claim 1, wherein an included angle between the outer cover annular plane and the outer cover conical surface is between 100 and 110 degrees.

8. The optical imaging lens according to claim 1, wherein a material of the outer cover is metal.

9. The optical imaging lens according to claim 1, wherein the outer cover may be a soft material, and a Shore A hardness thereof ranges from 70 to 90.

10. The optical imaging lens according to claim 1, wherein the outer cover is in contact with the lens barrel annular plane.

11. The optical imaging lens according to claim 1, wherein the optical imaging lens satisfies a following condition, 1.120≤Dcv/Dbr≤1.201, wherein Dcv is a maximum outer diameter of the outer cover on the reference plane, and Dbr is a maximum outer diameter of the lens barrel on the reference plane.

12. The optical imaging lens according to claim 1, wherein the optical imaging lens satisfies a following condition, 1.000≤Dinmax/Dinmin≤1.400, wherein Dinmax is a maximum inner diameter of the inner ring conical surface, and Dinmax is a minimum inner diameter of the inner ring conical surface.

13. The optical imaging lens according to claim 1, wherein the optical imaging lens satisfies a following condition, 1.150≤Dcvox/Dcvon≤1.500, wherein Dcvox is a maximum outer diameter of the outer cover, and Dcvon is a minimum outer diameter of the outer cover.

14. The optical imaging lens according to claim 1, wherein an air gap is between the outer surface of the front end portion of the lens barrel and the outer cover.

15. The optical imaging lens according to claim 14, wherein a length of the air gap on the optical axis is 20% to 40% of a length of the outer cover on the optical axis.

16. The optical imaging lens according to claim 1, wherein the outer surface of the lens barrel is provided with a plurality of dispensing areas and a plurality of matching areas arranged alternately, a number of the dispensing areas is the same as a number of the matching areas, and each of the dispensing areas has a receiving groove for receiving glue, wherein a depth of the receiving groove is between 0.005 mm and 0.100 mm, and the matching areas are in direct contact with the outer cover.

17. The optical imaging lens according to claim 16, wherein the number of the dispensing areas is at least 3 and at most 12.

18. The optical imaging lens according to claim 16, wherein the optical imaging lens satisfies a following condition, 3.100≤Pbr/Smin≤12.50, wherein Pbr is a minimum circumference of the lens barrel object-side opening, and Smin is a minimum arc length of one of the dispensing areas close to the object side.
